(19) United States
(12) Patent Application Publication
(10) Pub. No.: US 2013/0337144 A1
(43) Pub. Date: Dec. 19, 2013

(54) NUTRITIONAL PRODUCTS COMPRISING CALCIUM HMB AND CONJUGATED LINOLEIC ACID

(71) Applicants: Chron-Si Lai, Blacklick, OH (US); Charles R. Helmke, Gahanna, OH (US); Ann M. Kensler, Sugar Grove, OH (US)

(72) Inventors: Chron-Si Lai, Blacklick, OH (US); Charles R. Helmke, Gahanna, OH (US); Ann M. Kensler, Sugar Grove, OH (US)

(73) Assignee: ABBOTT LABORATORIES, ABBOTT PARK, IL (US)

(21) Appl. No.: 13/996,938

(22) PCT Filed: Dec. 20, 2011
(86) PCT No.: PCT/US11/66096

§ 371 Date: Sep. 3, 2013

Related U.S. Application Data
(60) Provisional application No. 61/425,809, filed on Dec. 22, 2010.

(51) Int. Cl. A23L 1/305

(52) U.S. Cl. CPC A23L 1/305
USPC 426/590; 426/648

(57) ABSTRACT

Disclosed are nutritional products comprising calcium beta-hydroxy-beta methylbutyrate, conjugated linoleic acid, and protein. The nutritional product forms include nutritional liquids and nutritional powders. The nutritional products not only provide benefits for individuals concerned with muscle health and functionality, but also exhibit physical stability, sensory and/or aesthetic benefits in each of the selected product forms.

### FIELD OF THE DISCLOSURE

The present disclosure relates to solid and liquid nutritional products comprising protein, calcium beta-hydroxy-beta methylbutyrate (calcium HMB) and conjugated linoleic acid (CLA).

### BACKGROUND OF THE DISCLOSURE

Protein-containing nutritional liquids and powders comprising a targeted selection of nutrition ingredients are well known and widely available, some of which may provide a sole source of nutrition while others may provide a supplemental source. These protein-containing nutritionals include powders that can be reconstituted with water or other aqueous liquid, as well as ready to drink nutritional liquids such as milk or protein based emulsions or non-emulsified liquids. Protein-containing nutritionals are often used to improve or maintain muscle health in athletes as well as individuals at risk, of or afflicted with, a disease or condition associated with the wasting of skeletal muscles.

Other nutrients known for affecting muscle health include beta-hydroxy-beta-methylbutyrate (HMB). HMB is a naturally occurring amino acid metabolite used in a variety of nutritional products and supplements. HMB helps build or maintain healthy muscle mass and strength in selected individuals. Calcium HMB is a commonly used form of HMB when formulated into oral nutritional products, which products may include tablets, capsules, reconstitutable powders, nutritional liquids and emulsions.

Yet another nutrient known for affecting muscle health is conjugated linoleic acid (CLA). CLA typically refers to any one or more of a group of at least 28 isomers of linoleic acid. CLA has been shown to reduce body fat and increase muscle mass, and has also been shown to possess anti-cancer and antioxidant properties. Because CLA has a distinctly bitter taste and causes a throat-burning sensation when taken orally, it is most typically incorporated into capsules and pills to minimize such effects.

It would therefore be desirable to administer protein, CLA and HMB to an individual to affect muscle health, especially since the three nutrients are not identical in the mechanism or pathway by which they provide such effects. It would also be even desirable to administer all three ingredients from a single nutritional product, especially a nutritional liquid, although to date this has been a challenge due to the product development needs of each. In a nutritional liquid, CLA has a bitter flavor and causes a throat-burning sensation, while the soluble calcium load from most HMB (or other calcium) sources may cause precipitation of many types of added protein, rendering the product potentially unstable.

The present disclosure is therefore directed to nutritional liquids and powders comprising relatively high concentrations of calcium HMB, CLA and protein, wherein the resulting nutritional product is physically stable over shelf life and provides favorable aesthetics and sensory qualities.

### SUMMARY OF THE DISCLOSURE

One embodiment is directed to a nutritional liquid comprising from about 0.01% to about 10% by weight of calcium HMB, from about 0.01% to about 10% by weight of conjugated linoleic acid, from about 1.0% to about 30% by weight of protein, and from about 50% to about 98% by weight of water.

Another embodiment is directed to a nutritional powder comprising from about 0.01% to about 10% by weight of calcium HMB, from about 0.01% to about 10% by weight of conjugated linoleic acid, and from about 1.0% to about 40% by weight of protein.

Another embodiment is directed to a nutritional product comprising calcium HMB, conjugated linoleic acid, protein, fat and carbohydrate.

Another embodiment is directed to a method of improving the physical stability of a nutritional product comprising calcium HMB. The method comprises introducing into the nutritional product a conjugated linoleic acid, wherein the weight ratio of conjugated linoleic acid to calcium HMB is from about 1.8:1 to about 2.3:1.

It has been found that the addition of CLA to nutritional products, such as nutritional liquids and solids, results in the products having a bitter or chalky taste and significant throat-burning effect upon consumption, even at very low concentrations. It has also been found that many nutritional liquids, such as nutritional emulsions, comprising calcium HMB in combination with protein are physically unstable, often resulting in the collection of excessive protein or other sediments at the bottom of the emulsion container, thus potentially reducing nutrient availability as well as the effective shelf-life of the product.

It has now been surprisingly discovered that these instability and flavor issues can be minimized or eliminated by formulating nutritional products with a combination of calcium HMB, CLA and protein. The nutritional products as described herein comprise specific combinations of calcium HMB, CLA and protein that not only provide benefits for individuals concerned with muscle strength, health and functionality, but also provide improved physical stability, sensory and/or aesthetic benefits in each of the selected product forms.

### BRIEF DESCRIPTION OF THE FIGURES

FIG. 1 shows two sample liquid nutritional formulations evaluated for stability and precipitation in Example 11.

### DETAILED DESCRIPTION OF THE DISCLOSURE

The nutritional products as described in the present disclosure comprise calcium HMB, CLA, and protein. The nutritional products have commercially acceptable taste properties, and are long term stable, even in liquid form. These and other features of the nutritional products, as well as some of the many optional variations and additions, are described in detail hereafter.

The term “calcium HMB” as used herein, unless otherwise specified, refers to the calcium salt of beta-hydroxy-beta-methylbutyrate (also referred to as beta-hydroxy-beta methylbutyric acid, beta-hydroxyl-3-methyl butyric acid, beta-hydroxy isovaleric acid, or HMB), which is most typically in a monohydrate form. All weights, percentages, and concentrations as used herein to characterize calcium HMB are based on the weight of calcium HMB monohydrate, unless otherwise specified.

The terms “fat” and “oil” as used herein, unless otherwise specified, are used interchangeably to refer to lipid materials derived or processed from plants or animals. These terms also include synthetic lipid materials so long as such synthetic materials are suitable for oral administration to humans.

The term “shelf stable” as used herein, unless otherwise specified, refers to a nutritional liquid that remains commercially stable after being packaged and then stored at 18-24° C. for at least 3 months, including from about 6 months to about 24 months, and also including from about 12 months to about 18 months.

The term “nutritional product” as used herein, unless otherwise specified, refers to liquids and powders comprising protein and one or more of fat and carbohydrate and is suitable for oral consumption by a human.

The term “nutritional liquid” as used herein, unless otherwise specified, refers to nutritional products in ready-to-drink liquid form and to nutritional liquids made by reconstituting the nutritional powders described herein prior to use.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the nutritional products of the present disclosure may also be substantially free of any optional or selected essential ingredient or feature described herein, provided that the remaining nutritional product still contains all of the required ingredients or features as described herein. In this context, and unless otherwise specified, the term “substantially free” means that the selected nutritional product contains less than a functional amount of the noted optional ingredient, typically less than about 1.0%, including less than about 0.5%, including less than about 0.1%, and also including zero percent, by weight of such optional or selected essential ingredient.

The nutritional products may comprise, consist of, or consist essentially of the essential elements of the products as described herein, as well as any additional or optional element described herein or otherwise useful in nutritional product applications.

### Product Form

The nutritional products of the present disclosure include both liquids and powders. The liquids may include solutions, suspensions, and emulsions. The powders may include any flowable or scoopable particulate solids or tablets that can be diluted with water or other aqueous liquid to form a nutritional liquid prior to use.

The nutritional products may be formulated with sufficient kinds and amounts of nutrients to provide a sole, primary, or supplemental source of nutrition, or to provide a specialized nutritional product for use in individuals afflicted with specific diseases or conditions or with a targeted nutritional benefit.

### Nutritional Powders

The nutritional powders (including pressed or solid nutritional powders including tablet forms) may be reconstituted by the intended user with a suitable aqueous liquid, typically water or other aqueous liquid, to form a nutritional liquid for immediate oral or enteral use. In this context, “immediate” use generally means within about 48 hours, more typically within about 24 hours, most typically right after or within 20 minutes of reconstitution.

The nutritional powders may include spray dried powders, dry mixed powders, agglomerated powders, combinations thereof, or powders prepared by other suitable methods.

### Nutritional Liquids

The nutritional liquids may be formulated in a variety of forms, including emulsions such as oil-in-water, water-in-oil, or complex aqueous emulsions, although such emulsions are most typically in the form of oil-in-water emulsions having a continuous aqueous phase and a discontinuous oil phase.

The nutritional liquids may be and typically are shelf stable. The nutritional liquids typically contain up to about 95% by weight of water, including from about 50% to about 95%, also including from about 60% to about 90%, and also including from about 70% to about 85%, of water by weight of the nutritional liquid.

The nutritional liquids may have a caloric density tailored to the nutritional needs of the ultimate user, although in most instances the liquids comprise from about 100 to about 500 kcal/240 ml, including from about 150 to about 350 kcal/240 ml, and also including from about 200 to about 320 kcal/240 ml.

The nutritional liquid may have a pH ranging from about 3.5 to about 8, but are most advantageously in a range of from about 4.5 to about 7.5, including from about 5.5 to about 7.3, including from about 6.2 to about 7.2.

Although the serving size for the nutritional liquid can vary depending upon a number of variables, a typical serving size ranges from about 100 to about 300 ml, including from about 150 to about 250 ml, and also including from about 190 to about 240 ml.

### Calcium Beta-Hydroxy-Beta Methylbutyrate (HMB)

The nutritional products described herein comprise calcium HMB, which means that the products are either formulated with the addition of calcium HMB, most typically as a monohydrate, or are otherwise prepared so as to contain calcium and HMB in the finished product. Any source of HMB is suitable for use in the nutritional products described herein provided that the finished product contains calcium and HMB, although such a source is preferably calcium HMB and is most typically added as such to the nutritional products during formulation.

The term “added calcium HMB” as used herein means a calcium salt of HMB, most typically as monohydrate calcium salt of HMB, as the HMB source added to the nutritional product.

Although calcium HMB monohydrate is the preferred source of HMB for use herein, other suitable sources may include HMB as the free acid, a salt, an anhydrous salt, an ester, a lactone, or other product forms that otherwise provide a bioavailable form of HMB from the nutritional product. Non-limiting examples of suitable salts of HMB for use herein include HMB salts, hydrated or anhydrous, of sodium, potassium, magnesium, chromium, calcium, or other non-toxic salt form. Calcium HMB monohydrate is preferred and is commercially available from Technical Sourcing International (TSI) of Salt Lake City, Utah.

The concentration of calcium HMB in the nutritional liquids may range up to about 10%, including from about 0.01% to about 10%, and also including from about 0.1% to about 5.0%, and also including from about 0.5% to about 2.0%, and also including from about 0.4% to about 1.5%, by weight of the nutritional liquid.

The concentration of calcium HMB in the nutritional powders may range up to about 10%, including from about 0.01% to about 10%, and also including from about 0.1% to about 7.0%, and also including from about 1.0% to about 5.0%, and also including from about 1.0% to about 4.0%, by weight of the nutritional powder.

The nutritional products may provide from about 0.5 to about 2.5 grams, including from about 1.0 to about 1.7 grams, including about 1.5 grams of HMB per serving, wherein a serving may range from about 100 to about 400 ml, including from about 150 to about 340 ml, and also including from about 230 to about 300 ml of the nutritional liquid. Servings may be once daily, twice daily, three times daily or more to allow for the desired level of nutrition.

### Conjugated Linoleic Acid (CLA)

The nutritional products comprise CLA, which means that the products are either formulated with the addition of CLA, or are otherwise prepared so as to contain CLA in the finished product. Any source of CLA is suitable for use herein provided that the finished product contains CLA, although such a source is preferably CLA and is most typically added as such to the nutritional products during formulation.

A variety of CLA sources are commercially available for formulation into nutritional products, most of which are in the form of liquid oils at room temperature and comprise up to 100%, more typically from 70-95% CLA in oil.

The concentration of CLA in the nutritional liquids may range up to about 10%, including from about 0.01% to about 10%, and also including from about 0.5% to about 5.0%, and also including from about 1.0% to about 3.0%, and also including from about 1.0% to about 2.0%, by weight of the nutritional liquid.

The concentration of CLA in the nutritional powders may range up to about 10%, including from about 0.01% to about 10%, and also including from about 0.5% to about 10.0%, and also including from about 3.0% to about 10.0%, and also including from about 3.0% to about 7.0%, by weight of the nutritional powder.

The nutritional products most typically provide from about 0.5 to about 5.0 grams, including from about 2.0 to about 4.0 grams, including about 3.4 grams of CLA per serving of the nutritional liquid prepared from the powder.

In some embodiments, the concentration of CLA and calcium HMB in the nutritional products may be defined as a weight ratio of CLA to calcium HMB. Generally, the weight ratio of CLA to calcium HMB is from about 1.2:1.0 to about 3.0:1.0, including from about 1.5:1 to about 2.5:1, including from about 1.8:1 to about 2.3:1, and further including from about 1.8:1 to about 2.1:1.

Although it is within the scope of the present disclosure to have nutritional products having a weight ratio of CLA to calcium HMB of greater than 2.1:1, it may be desirable in many embodiments to have a weight ratio of CLA to calcium HMB of 2.1:1 or less to ensure that there is sufficient calcium in the product, from the calcium HMB, to chelate and neutralize the CLA and provide the improved physical stability as discussed herein. In those embodiments where the weight ratio of CLA to calcium HMB is greater than 2.1:1, it may be desirable in some embodiments to add an additional calcium source to the nutritional product to ensure that there is sufficient calcium in the product such that the CLA is substantially chelated and neutralized to provide the desired physical stability of the product. Additional sources of calcium may include, for example, calcium hydroxide, calcium carbonate, and/or calcium citrate. Other neutralizing agents such as magnesium hydroxide could also be utilized.

### Macronutrients

The nutritional products further comprise protein and may optionally comprise one or more other macronutrients in addition to the calcium HMB and CLA described herein. The optional macronutrients include lipids and carbohydrates.

Macronutrients suitable for use herein include any protein, lipid, or carbohydrate or source thereof that is known for or otherwise suitable for use in an oral nutritional product, provided that the optional macronutrient is safe and effective for oral administration and is otherwise compatible with the other ingredients in the nutritional product.

The concentration or amount of optional lipid, carbohydrate, and protein in the nutritional product can vary considerably depending upon the particular nutritional application of the product. These optional macronutrients are most typically formulated within any of the embodied ranges described in the following tables.

| Nutrient (% total calories) | Example A | Example B | Example C |
|---|---|---|---|
| Carbohydrate | 0-100 | 10-70 | 40-50 |
| Lipid | 0-100 | 20-65 | 35-55 |
| Protein | 0-100 | 5-40 | 15-25 |

Each numerical value preceded by the term “about”

| Nutrient (wt % composition) | Example D | Example E | Example F |
|---|---|---|---|
| Carbohydrate | 0-98 | 1-50 | 10-30 |
| Lipid | 0-98 | 1-30 | 3-15 |
| Protein | 0-98 | 1-30 | 2-10 |

Each numerical value preceded by the term “about”

### Protein

The nutritional products further comprise a protein. Any protein or source thereof that is suitable for use in oral nutritional products and is compatible with the essential elements and features of such products is suitable.

The concentration of protein in the nutritional liquid may range from about 1.0% to about 30%, including from about 1.0% to about 15%, and also including from about 1% to about 10%, and also including from about 1.0% to about 7.0%, by weight of the nutritional liquid.

For powder embodiments, the concentration of protein may range from about 1.0% to about 50%, including from about 10% to about 50%, and also including from about 10% to about 30%, by weight of the nutritional powder.

Non-limiting examples of suitable protein or sources thereof for use in the nutritional products include hydrolyzed, partially hydrolyzed or non-hydrolyzed proteins or protein sources, which may be derived from any known or otherwise suitable source such as milk (e.g., casein, whey), animal (e.g., meat, fish), cereal (e.g., rice, corn), vegetable (e.g., soy or pea) or combinations thereof. Non-limiting examples of such proteins include milk protein isolates, milk protein concentrates, casein protein isolates, whey protein, sodium or calcium caseinates, whole cow's milk, partially or completely defatted milk, soy protein isolates, soy protein concentrates, and so forth. In one embodiment, the protein system includes at least about 50% sodium caseinate, desirably at least about 60% sodium caseinate, desirably at least about 70% sodium caseinate, desirably at least about 80% sodium caseinate, desirably at least about 90% sodium caseinate or desirably at least about 100% sodium caseinate.

In another specific embodiment, the protein system includes a combination of protein sources including calcium (or sodium) caseinate and soy protein isolate. In another specific embodiment, the protein system includes a combination of protein sources including sodium (or calcium) caseinate, milk protein concentrate, soy protein isolate, and whey protein concentrate.

### Carbohydrate

The nutritional products may further comprise any carbohydrates that are suitable for use in an oral nutritional product and are compatible with the essential elements and features of such products.

Carbohydrate concentrations in the nutritional liquid, for example, may range from about 5.0% to about 40%, including from about 7.0% to about 30%, including from about 10% to about 25%, by weight of the nutritional liquid. In one specific embodiment, the carbohydrate is present in the nutritional liquid in an amount of about 10.2%, by weight of the nutritional liquid.

Carbohydrate concentrations in the nutritional solids may range from about 10% to about 90%, including from about 20% to about 80%, further including from about 40% to about 60%, by weight of the nutritional solid. In one specific embodiment, the carbohydrate is present in the nutritional solid in an amount of about 58%, by weight of the nutritional solid.

Non-limiting examples of suitable carbohydrates or sources thereof for use in the nutritional products described herein may include maltodextrin, hydrolyzed or modified starch or cornstarch, glucose polymers, corn syrup, corn syrup solids, rice-derived carbohydrates, sucrose, glucose, fructose, lactose, high fructose corn syrup, honey, sugar alcohols (e.g., maltitol, erythritol, sorbitol), artificial sweeteners (e.g., sucralose, acesulfame potassium, stevia) and combinations thereof. A particularly desirable carbohydrate is a low dextrose equivalent (DE) maltodextrin.

In one specific embodiment, the carbohydrate system includes a combination of carbohydrate sources including maltodextrin (optionally low DE maltodextrin) and sucrose.

### Fat

The nutritional products may further comprise fat, most typically as emulsified fat. Any fat that is suitable for use in oral nutritional products and is compatible with the essential elements and features of such products is suitable.

The fat may be present in the nutritional liquids in an amount of from about 1.0% to about 30%, including from about 1.0% to about 20%, and also including from about 1.0% to about 15%, and also including from about 1.5% to about 5.0%, by weight of the nutritional liquid. In one specific embodiment, the nutritional liquid includes fat in an amount of about 1.6%, by weight of the nutritional liquid.

The fat may be present in the nutritional solids in an amount of from about 1.0% to about 30%, including from about 1.0% to about 20%, and also including from about 1.0% to about 15%, and also including from about 5.0% to about 10%, by weight of the nutritional solid. In one specific embodiment, the nutritional solid includes fat in an amount of about 7.5%, by weight of the nutritional solid.

Suitable sources of fat for use herein include any fat or fat source that is suitable for use in an oral nutritional product and is compatible with the essential elements and features of such products.

Non-limiting examples of suitable fats or sources thereof for use in the nutritional emulsions described herein include coconut oil, fractionated coconut oil, soy oil, corn oil, olive oil, safflower oil, high oleic safflower oil, MCT oil (medium chain triglycerides), sunflower oil, high oleic sunflower oil, palm and palm kernel oils, palm olein, canola oil, marine oils, cottonseed oils, and combinations thereof.

In one specific embodiment, the fat system includes a combination of fat sources including a high oleic safflower oil, canola oil, and soy oil.

### Methods of Manufacture

The nutritional liquids may be manufactured by any known or otherwise suitable method for making nutritional liquids, including emulsions such as milk-based nutritional emulsions.

In one suitable manufacturing process, a nutritional liquid is prepared using at least three separate slurries, including a protein-in-fat (PIF) slurry, a carbohydrate-mineral (CHO-MIN) slurry, and a protein-in-water (PIW) slurry. The PIF slurry is formed by heating and mixing the selected oils (e.g., canola oil, corn oil, etc.) and then adding an emulsifier (e.g., lecithin), fat soluble vitamins, and a portion of the total protein (e.g., milk protein concentrate, etc.) with continued heat and agitation. The CHO-MIN slurry is formed by adding with heated agitation to water: minerals (e.g., potassium citrate, dipotassium phosphate, sodium citrate, etc.), trace and ultra trace minerals (TM/UTM premix), thickening or suspending agents (e.g. Avicel, gellan, carrageenan), and calcium HMB and CLA. The resulting CHO-MIN slurry is held for 10 minutes with continued heat and agitation before adding additional minerals (e.g., potassium chloride, magnesium carbonate, potassium iodide, etc.), carbohydrates (e.g., fructooligosaccharide, sucrose, corn syrup, etc.). The PIW slurry is then formed by mixing with heat and agitation the remaining protein (e.g., sodium caseinate, soy protein concentrate, etc.) into water.

The resulting slurries are then blended together with heated agitation and the pH adjusted to the desired range, typically from 6.6-7.0, after which the composition is subjected to high-temperature short-time (HTST) processing during which the composition is heat treated, emulsified and homogenized, and then allowed to cool. Water soluble vitamins and ascorbic acid are added, the pH is again adjusted to the desired range if necessary, flavors are added, and water is added to achieve the desired total solid level. The composition is then aseptically packaged to form an aseptically packaged nutritional emulsion, or the composition is added to retort stable containers and then subjected to retort sterilization to form retort sterilized nutritional emulsions.

The manufacturing processes for the nutritional emulsions may be carried out in ways other than those set forth herein without departing from the spirit and scope of the present disclosure. The present embodiments are, therefore, to be considered in all respects illustrative and not restrictive and that all changes and equivalents also come within the description of the present disclosure.

The nutritional solid, such as a spray dried nutritional powder, may be prepared by any collection of known or otherwise effective techniques, suitable for making and formulating a spray dried nutritional powder.

The spray drying step may likewise include any spray drying technique that is known for or otherwise suitable for use in the production of nutritional powders. Many different spray drying methods and techniques are known for use in the nutrition field, all of which are suitable for use in the manufacture of the spray dried nutritional powders herein.

One method of preparing the spray dried nutritional powder comprises forming and homogenizing an aqueous slurry or liquid comprising HMB, CLA and protein, and optionally carbohydrate, and fat, and then spray drying the slurry or liquid to produce a spray dried nutritional powder. The method may further comprise the step of spray drying, dry mixing, or otherwise adding additional nutritional ingredients, including any one or more of the ingredients described herein, to the spray dried nutritional powder.

The methods of manufacture are preferably formulated with calcium HMB, which is most typically formulated as calcium HMB monohydrate, as the HMB source for use in the methods.

### Optional Ingredients

The nutritional products described herein may further comprise other optional ingredients that may modify the physical, nutritional, chemical, hedonic or processing characteristics of the products or serve as pharmaceutical or additional nutritional components when used in the targeted population. Many such optional ingredients are known or otherwise suitable for use in other nutritional products and may also be used in the nutritional products described herein, provided that such optional ingredients are safe and effective for oral administration and are compatible with the essential and other ingredients in the selected product form.

Non-limiting examples of such optional ingredients include preservatives, antioxidants, emulsifying agents, buffers, fructooligosaccharide, chromium picolinate, pharmaceutical actives, additional nutrients as described herein, colorants, flavors, thickening agents and stabilizers, and so forth.

The products may further comprise vitamins or related nutrients, non-limiting examples of which include vitamin A, vitamin D, vitamin E, vitamin K, thiamine, riboflavin, pyridoxine, vitamin B12, carotenoids, niacin, folic acid, pantothenic acid, biotin, vitamin C, choline, inositol, salts, and derivatives thereof, and combinations thereof.

The products may further comprise minerals, non-limiting examples of which include phosphorus, magnesium, calcium, iron, zinc, manganese, copper, sodium, potassium, molybdenum, chromium, selenium, chloride, and combinations thereof.

The products may also include one or more flavoring or masking agents. Suitable flavoring or masking agents include natural and artificial sweeteners, sodium sources such as sodium chloride, and hydrocolloids, such as guar gum, xanthan gum, carrageenan, gellan gum, gum acacia, and combinations thereof.

### Methods of Use

The nutritional products are useful as a nutrition source as well as to help promote healthy muscle development and maintenance and for enhancing performance endurance in individuals and athletes. Additionally, the nutritional products may be particularly suitable for use in older and elderly individuals in need of maintaining healthy muscle mass, strength and functionality. The nutritional products may help in reducing the frailty of older adults and improve muscle tone.

Such methods are further directed to provide the individual upon administration of such products, most typically after daily use over an extended period of time of from about 1 to about 6 months, including from about 1 to about 3 months, one or more of 1) to support maintenance and growth of lean body mass, 2) to support maintenance of strength and/or muscle strength and growth, 3) to decrease protein breakdown and damage of muscle cells, 4) to help with muscle recovery following exercise or other trauma, and 5) to reduce muscle protein breakdown following exercise.

### EXAMPLES

The following examples illustrate specific embodiments and or features of the nutritional products of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the composition, unless otherwise specified.

The exemplified compositions are nutritional products that may be prepared in accordance with manufacturing methods well known in the nutrition industry for preparing nutritional emulsions and spray dried nutritional powders.

### Examples 1-5

Examples 1-5 illustrate nutritional powders of the present disclosure including calcium HMB, CLA and protein, the ingredients of which are listed in the table below. These products may be prepared by spray drying methods in separate batches, and may be reconstituted with water prior to use to the desired target ingredient concentrations. All ingredient amounts are listed as kg per 1000 kg batch of product, unless otherwise specified.

| Ingredient | Ex. 1 | Ex. 2 | Ex. 3 | Ex. 4 | Ex. 5 |
|---|---|---|---|---|---|
| Maltodextrin | 436.7 | 436.7 | 436.7 | 436.7 | 436.7 |
| Sucrose | 145.5 | 145.5 | 145.5 | 145.5 | 145.5 |
| Calcium Caseinate | 129.1 | 129.1 | 129.1 | 129.1 | 129.1 |
| CLA | 67.0 | 63.65 | 70.35 | 60.3 | 73.7 |
| Isolated Soy Protein | 57.7 | 57.7 | 57.7 | 61.7 | 57.7 |
| FOS Powder | 33.6 | 33.6 | 33.6 | 33.6 | 32.6 |
| HO sunflower oil | 33.1 | 30.1 | 36.1 | 33.1 | 33.1 |
| Calcium HMB | 31.6 | 34.6 | 28.6 | 27.6 | 32.6 |
| Canola Oil | 28.3 | 28.3 | 28.3 | 28.3 | 28.3 |
| Soy Oil | 13.3 | 13.3 | 13.3 | 13.3 | 13.3 |
| Potassium Citrate | 10.3 | 10.3 | 10.3 | 10.3 | 10.3 |
| Sodium Citrate | 5.8 | 5.8 | 5.8 | 5.8 | 5.8 |
| Potassium Chloride | 5.2 | 5.2 | 5.2 | 5.2 | 5.2 |
| Magnesium Chloride | 4.7 | 4.7 | 4.7 | 4.7 | 4.7 |
| Potassium hydroxide | 3.1 | 3.1 | 3.1 | 3.1 | 3.1 |
| Sodium phosphate dibasic dihydrate | 3.0 | 3.0 | 3.0 | 3.0 | 3.0 |
| Sodium chloride | 2.5 | 2.5 | 2.5 | 2.5 | 2.5 |
| Choline Chloride | 1.8 | 1.8 | 1.8 | 1.8 | 1.8 |
| Vanilla Flavor | 1.8 | 1.8 | 1.8 | 1.8 | 1.8 |
| Sodium phosphate monobasic monohydrate | 1.6 | 1.6 | 1.6 | 1.6 | 1.6 |
| Potassium phosphate dibasic trihydrate | 1.1 | 1.1 | 1.1 | 1.1 | 1.1 |
| Flavor | 1.0 | 1.0 | 1.0 | 1.0 | 1.0 |
| Vitamin premix | 1.0 | 1.0 | 1.0 | 1.0 | 1.0 |
| Ascorbyl palmitate | 0.243 | 0.243 | 0.243 | 0.243 | 0.243 |
| Ascorbic acid | 0.240 | 0.240 | 0.240 | 0.240 | 0.240 |
| Antioxidant | 0.116 | 0.116 | 0.116 | 0.116 | 0.116 |
| Ferrous sulfate | 0.092 | 0.092 | 0.092 | 0.092 | 0.092 |
| Vitamin premix | 0.065 | 0.065 | 0.065 | 0.065 | 0.065 |
| Zinc sulfate monohydrate | 0.057 | 0.057 | 0.057 | 0.057 | 0.057 |
| Manganese sulfate | 0.045 | 0.045 | 0.045 | 0.045 | 0.045 |
| Mineral mix copper sulfate | 0.035 | 0.035 | 0.035 | 0.035 | 0.035 |
| Beta carotene | 0.005 | 0.005 | 0.005 | 0.005 | 0.005 |
| Chromium chloride | 0.001 | 0.001 | 0.001 | 0.001 | 0.001 |
| Sodium molybdate | 0.0012 | 0.0012 | 0.0012 | 0.0012 | 0.0012 |
| Potassium iodide | 0.001 | 0.001 | 0.001 | 0.001 | 0.001 |
| Sodium selenite | 0.0004 | 0.0004 | 0.0004 | 0.0004 | 0.0004 |
| Citric acid | AN | AN | AN | AN | AN |
| Potassium hydroxide | AN | AN | AN | AN | AN |
| Magnesium sulfate dry | AN | AN | AN | AN | AN |
| Ultra micronized tricalcium phosphate | AN | AN | AN | AN | AN |
| Ascorbic acid | AN | AN | AN | AN | AN |

AN = As Needed

### Examples 6-10

Examples 6-10 illustrate nutritional emulsion embodiments of the present disclosure, the ingredients of which are listed in the table below. All amounts are listed as kilogram per 1000 kilogram batch of product, unless otherwise specified.

| Ingredient | Ex. 6 | Ex. 7 | Ex. 8 | Ex. 9 | Ex. 10 |
|---|---|---|---|---|---|
| Water | Q.S. | Q.S. | Q.S. | Q.S. | Q.S. |
| Sucrose | 89.3 | 89.3 | 89.3 | 89.3 | 89.3 |
| Maltodextrin | 29.7 | 29.7 | 29.7 | 29.7 | 29.7 |
| Sodium Caseinate | 25.9 | 25.9 | 25.9 | 25.9 | 25.9 |
| Milk Protein Concentrate | 19.1 | 19.1 | 19.1 | 19.1 | 19.1 |
| CLA | 14.2 | 13.5 | 14.9 | 12.8 | 15.6 |
| Soy Protein Isolate | 11.9 | 11.9 | 9.9 | 12.9 | 13.9 |
| Potassium Citrate | 7.9 | 7.9 | 7.9 | 7.9 | 7.9 |
| Soy Oil | 6.4 | 5.4 | 6.4 | 6.4 | 6.4 |
| Calcium HMB | 6.7 | 7.7 | 8.7 | 5.7 | 4.7 |
| Canola Oil | 5.5 | 5.5 | 5.5 | 5.5 | 5.5 |
| Corn Oil | 4.6 | 4.6 | 4.6 | 4.6 | 4.6 |
| Whey Protein Concentrate | 3.5 | 3.5 | 3.5 | 3.5 | 3.5 |
| Magnesium Phosphate Dibasic | 3.1 | 3.1 | 3.1 | 3.1 | 3.1 |
| Flavor | 2.0 | 2.0 | 2.0 | 2.0 | 2.0 |
| Microcrystalline Cellulose | 2.0 | 2.0 | 2.0 | 2.0 | 2.0 |
| Soy Lecithin | 1.5 | 1.5 | 1.5 | 1.5 | 1.5 |
| Sodium Phosphate Dibasic Dihydrate | 1.3 | 1.3 | 1.3 | 1.3 | 1.3 |
| Potassium Phosphate Dibasic | 0.985 | 0.985 | 0.985 | 0.985 | 0.985 |
| Potassium Chloride | 0.729 | 0.729 | 0.729 | 0.729 | 0.729 |
| Choline Chloride | 0.480 | 0.480 | 0.480 | 0.480 | 0.480 |
| Ascorbic Acid | 0.469 | 0.469 | 0.469 | 0.469 | 0.469 |
| Calcium Carbonate | 0.451 | 0.451 | 0.451 | 0.451 | 0.451 |
| Caramel Flavor | 0.450 | 0.450 | 0.450 | 0.450 | 0.450 |
| Creamer | 0.450 | 0.450 | 0.450 | 0.450 | 0.450 |
| UTM/TM Premix | 0.367 | 0.367 | 0.367 | 0.367 | 0.367 |
| 45% Potassium Hydroxide | 0.323 | 0.323 | 0.323 | 0.323 | 0.323 |
| Carrageenan | 0.200 | 0.200 | 0.200 | 0.200 | 0.200 |
| Water Soluble Vitamin Premix | 0.185 | 0.185 | 0.185 | 0.185 | 0.185 |
| Vitamin DEK Premix | 0.067 | 0.067 | 0.067 | 0.067 | 0.067 |
| Sodium Chloride | 0.060 | 0.060 | 0.060 | 0.060 | 0.060 |
| Gellan Gum | 0.050 | 0.050 | 0.050 | 0.050 | 0.050 |
| Vitamin A Palmitate | 0.0082 | 0.0082 | 0.0082 | 0.0082 | 0.0082 |
| Corn oil carrier | Q.S. | Q.S. | Q.S. | Q.S. | Q.S. |
| Vitamin D₃ | 399 mg | 399 mg | 399 mg | 399 mg | 399 mg |
| Potassium Iodide | 194 mg | 194 mg | 194 mg | 194 mg | 194 mg |

### Example 11

In this Example, the stability of a nutritional emulsion including CLA, HMB, and protein is analyzed and compared to a control sample emulsion without CLA.

Formulations for both the control sample nutritional emulsion and the nutritional emulsion including CLA are set forth in the table below. All ingredient amounts are listed as kilogram per 1000 kilogram batch of product, unless otherwise specified. The emulsions are prepared using the conventional methods described herein.

| Ingredient | Control | Emulsion w/ CLA |
|---|---|---|
| Water | Q.S. | Q.S. |
| Sucrose | 89.3 | 89.3 |
| Maltodextrin | 29.7 | 29.7 |
| Sodium Caseinate | 25.9 | 25.9 |
| Milk Protein Concentrate | 19.1 | 19.1 |
| CLA | 0.0 | 14.2 |
| Soy Protein Isolate | 11.9 | 11.9 |
| Potassium Citrate | 7.9 | 7.9 |
| Soy Oil | 6.4 | 6.4 |
| Calcium HMB | 6.7 | 6.7 |
| Canola Oil | 5.5 | 5.5 |
| Corn Oil | 4.6 | 4.6 |
| Whey Protein Concentrate | 3.5 | 3.5 |
| Magnesium Phosphate Dibasic | 3.1 | 3.1 |
| Flavor | 2.0 | 2.0 |
| Microcrystalline Cellulose | 2.0 | 2.0 |
| Soy Lecithin | 1.5 | 1.5 |
| Sodium Phosphate Dibasic Dihydrate | 1.3 | 1.3 |
| Potassium Phosphate Dibasic | 0.985 | 0.985 |
| Potassium Chloride | 0.729 | 0.729 |
| Choline Chloride | 0.480 | 0.480 |
| Ascorbic Acid | 0.469 | 0.469 |
| Calcium Carbonate | 0.451 | 0.451 |
| Flavor | 0.450 | 0.450 |
| Creamer | 0.450 | 0.450 |
| UTM/TM Premix | 0.367 | 0.367 |
| 45% Potassium Hydroxide | 0.323 | 0.323 |
| Carrageenan | 0.200 | 0.200 |
| Water Soluble Vitamin Premix | 0.185 | 0.185 |
| Vitamin DEK Premix | 0.0675 | 0.067 |
| Sodium Chloride | 0.0601 | 0.060 |
| Gellan Gum | 0.0500 | 0.050 |
| Vitamin A Palmitate | 0.0082 | 0.0082 |
| Corn oil (carrier) | Q.S. | Q.S. |
| Vitamin D₃ | 399 mg | 399 mg |
| Potassium Iodide | 194.4 mg | 194.4 mg |

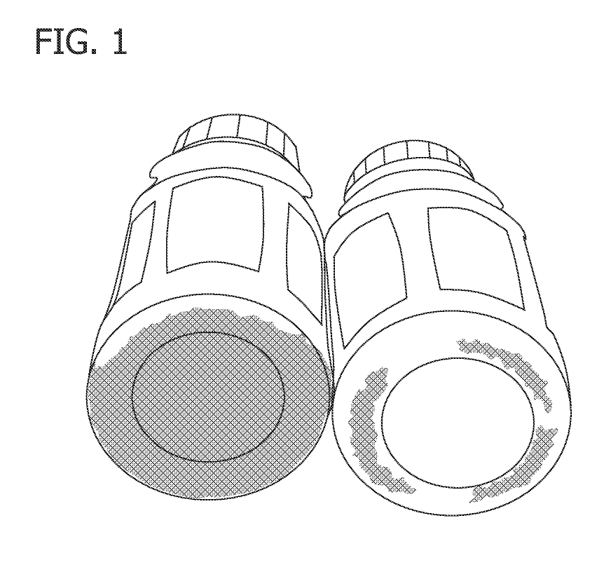

The nutritional emulsions are packaged in 240-ml plastic containers and retort sterilized using conventional methods. Visual inspections surprisingly showed that the nutritional emulsion including CLA and calcium HMB showed less sediment after 12 months of storage at ambient temperature than the control that included calcium HMB but no CLA (See FIG. 1; control sample on the left and emulsion with CLA on the right). Stated another way, the inclusion of CLA in the nutritional emulsion surprisingly improved the physical stability of the calcium HMB-containing nutritional product after 12 months as significantly less precipitate was formed and settled at the bottom of the container.

### Example 12

In this Example, the nutritional emulsion including CLA, calcium HMB, and protein and the control sample without the addition of CLA of Example 11 are analyzed for taste quality. Particularly, because CLA provides a bitter taste and imparts a strong throat irritation upon direct ingestion, it has been difficult to incorporate this functional ingredient into nutritional products without drastically impairing the taste of the product to the point where it is commercially undesirable.

The sample emulsions are analyzed by a trained sensory panel for intensity of various tastes: sweet, salty, sour, bitter, flavor intensity, base intensity, and phenolic. Specifically, once the emulsions are prepared, 5 trained panelists consume 8 fluid ounces of the each of the nutritional emulsions. After consumption of each emulsion, each panelist rates the tastes using the profilers set for in the table below. The results are then averaged.

| Profiler | Description |
|---|---|
| — | Not detected |
| )( | Threshold |
| ½ | Very Slight |
| 1 | Slight |
| 1½ | Slight to Moderate |
| 2 | Moderate |
| 2½ | Moderate to Strong |
| 3 | Strong |

As shown in the Results Table below, it was surprisingly found that taste quality of the nutritional emulsion including CLA was very similar to the control sample that did not include any CLA. Significantly and surprisingly, there was no difference in bitterness between the samples. These results indicate that the CLA-containing nutritional emulsion has similar taste characteristics to the control emulsion that did not include CLA and would be commercially acceptable from a taste standpoint. Additionally, these results indicate that a nutritional product having acceptable taste qualities can be formulated including both CLA and calcium HMB in combination with protein.

| Sample | Taste | Profiler Result |
|---|---|---|
| Control Sample (HMB only) | Sweet | 1½ |
| | Sour | 1 |
| | Salty | ½ |
| | Bitter | — |
| | Flavor Intensity | — |
| | Base Intensity | 1½ |
| | Phenolic | — |
| Nutritional Emulsion | Sweet | 1½ |
| Including CLA + HMB | Sour | 1 |
| | Salty | ½ |
| | Bitter | — |
| | Flavor Intensity | — |
| | Base Intensity | 1½ |
| | Phenolic | 1 |

1.-15. (canceled)

16. A nutritional product comprising from about 0.01% to about 10% by weight of calcium beta-hydroxy-beta-methylbutyrate, from about 0.01% to about 10% by weight of conjugated linoleic acid, and from about 1% to about 50% by weight of protein.

17. The nutritional product of claim 16 further comprising from about 50% to about 98% by weight of water and from about 1% to about 30% by weight of protein, wherein the nutritional product is a nutritional liquid, and wherein interaction between the conjugated linoleic acid and calcium reduces precipitation and sedimentation in the nutritional liquid.

18. The nutritional product of claim 17 comprising from about 0.1% to about 5% by weight of calcium beta-hydroxy-beta-methylbutyrate.

19. The nutritional product of claim 17 comprising from about 0.5% to about 2% by weight of calcium beta-hydroxy-beta-methylbutyrate.

20. The nutritional product of claim 17 comprising from about 0.5% to about 5% by weight of conjugated linoleic acid.

21. The nutritional product of claim 17 comprising from about 1% to about 3% by weight of conjugated linoleic acid.

22. The nutritional product of claim 17 comprising from about 1% to about 7% by weight of protein.

23. The nutritional product of claim 17, wherein the nutritional liquid is an aqueous emulsion further comprising from about 1% to about 30% by weight of fat.

24. The nutritional product of claim 17, wherein the nutritional liquid is packaged in a hermetically sealed container and is shelf stable at a temperature of from about 18° C. to about 24° C. for at least about 3 months.

25. The nutritional product of claim 17, wherein the weight ratio of conjugated linoleic acid to calcium beta-hydroxy-beta-methylbutyrate is from about 1.2:1 to about 3:1.

26. The nutritional product of claim 16, wherein the nutritional product is a nutritional powder.

27. The nutritional product of claim 26 comprising from about 1% to about 5% by weight of calcium beta-hydroxy-beta-methylbutyrate.

28. The nutritional product of claim 26 comprising from about 3% to about 7% by weight of conjugated linoleic acid.

29. The nutritional product of claim 26, wherein the weight ratio of conjugated linoleic acid to calcium beta-hydroxy-beta-methylbutyrate is from about 1.2:1 to about 3:1.

30. A nutritional product comprising calcium beta-hydroxy-beta-methylbutyrate, conjugated linoleic acid, protein, fat, and carbohydrate, wherein the weight ratio of conjugated linoleic acid to calcium beta-hydroxy-beta-methylbutyrate is from about 1.2:1 to about 3:1.

31. A method of improving the physical stability of a packaged nutritional liquid comprising calcium beta-hydroxy-beta-methylbutyrate and protein, the method comprising:
forming a nutritional liquid comprising protein, carbohydrate, fat, calcium beta-hydroxy-beta-methylbutyrate, and conjugated linoleic acid, wherein the weight ratio of conjugated linoleic acid to calcium beta-hydroxy-beta-methylbutyrate is from about 1.2:1 to about 3:1; and
packaging the nutritional liquid to form the packaged nutritional liquid;
wherein the interaction between the conjugated linoleic acid and calcium reduces precipitation and sedimentation in the packaged nutritional liquid, thereby improving the physical stability of the packaged nutritional liquid.

32. The method of claim 31, wherein the nutritional liquid comprises from about 1% to about 7% by weight of protein.

33. The method of claim 31, wherein the packaged nutritional liquid is shelf stable at a temperature of from about 18° C. to about 24° C. for at least about 3 months.

34. The method of claim 31, wherein the weight ratio of conjugated linoleic acid to calcium beta-hydroxy-beta-methylbutyrate is less than 2.1:1.

35. The method of claim 34, wherein the nutritional liquid comprises from about 0.01% to about 10% by weight of conjugated linoleic acid.
